(19) United States
(12) Patent Application Publication
(10) Pub. No.: US 2008/0263647 A1
(43) Pub. Date: Oct. 23, 2008

(54) System and Method For Providing Network Device Authentication

(75) Inventors: Bruce Gordon Barnett, Troy, NY (US); Daniel White Sexton, Niskayuna, NY (US); Ping Liu, Simpsonville, SC (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/094,899

(22) PCT Filed: Jul. 16, 2007
(86) PCT No.: PCT/US07/73602

§ 371 Date: May 23, 2008

Related U.S. Application Data
(60) Provisional application No. 60/832,642, filed on Jul. 21, 2006.

(30) Foreign Application Priority Data
Jun. 14, 2007 (US) 11762819

(51) Int. Cl. H04L 9/32

(52) U.S. Cl. 726/6

(57) ABSTRACT

A secure framework for wireless sensor networks. The framework provides a system and method for providing network device authentication. The system and method comprises installing a unique device key in a network device and creating a chain of keys, wherein each subsequent key is encrypted using the previous key. The method executes an authentication process for storing and issuing keys, wherein the authentication process uses a unique device key to install a device site key in the network device and uses the device site key and the unique device key to authenticate the network device for communicating with a wireless network router, wherein the wireless network router creates a unique network-device-router key. The unique network-device-router key is used to authenticate the network device for communicating over the wireless network using an encrypted network session key and allows secure encrypted link-layer communications over the wireless network.

### CROSS REFERENCE TO RELATED APPLICATIONS

This application claims priority to U.S. Provisional Application Ser. No. 60/832,642, filed Jul. 21, 2006 and U.S. application Ser. No. 11/762,819, filed Jun. 14, 2007 of which both are incorporated herein by reference in their entirety.

### FEDERAL RESEARCH STATEMENT

This invention was made with Government support under Contract No. DE-FC36-04GO14001 awarded by the United States Government. The Government has certain rights in the invention.

### BACKGROUND

Wireless sensor networks offer significant advantages in factory environments, as the cost of running wire can range from $40 to $2000 per foot. Readily available commercial sensors include radios with encryption capability. However, secure frameworks for sensor networks lack robustness, as they tend to focus on a limited number of threats. A more viable solution has to consider a greater number of security threats, and attempt to reduce the risk in as many as possible. It must also be practical and flexible to allow deployment in a variety of environments.

Conventional sensor networks present additional implementation challenges. Battery-powered sensors must limit power consumption to be practical. They also may have limited support hardware for encryption such as asymmetric keys.

On-site and off-site attacks on sensor networks may be categorized as different due to a difference in detection and response. Further, reverse engineering, devices with back doors, and physical attacks are considered as threats to sensor networks as well.

No secure framework can eliminate all threats. However, all of the threats must be considered to evaluate the effectiveness of the approach.

### SUMMARY

According to an exemplary embodiment discloses a system provides wireless network device authentication. The system comprises creating a secure communications network using one or more backend servers, one or more network gateways, a plurality of wireless routers, a plurality of leaf-node sensors, each having a unique a device key. The backend servers, network gateways, wireless routers and leaf-node sensors are connected via a communications network and the backend server and the network gateway authenticates the device key of a leaf-node sensor. The network gateway creates a device site key that is unique to the communications network and allows the backend servers, gateway servers, wireless routers and leaf-node sensors to communicate with each other. Next the network gateway authenticates the leaf-node and creates a leaf-node router key to set up a secure link between the leaf-node and the wireless router, and the wireless router creates a unique Session Key for each authenticated leaf-node thereby establishing a secure communications network.

According to another exemplary embodiment, a method provides a method for providing network device authentication. The method comprises installing a unique device key in a network device and creating a chain of keys, wherein each subsequent key is encrypted using the previous key. The method executes an authentication process for storing and issuing keys, wherein the authentication process uses the unique device key to install a device site key in the network device and uses the device site key and the unique device key to authenticate the network device for communicating with a wireless network router, wherein the wireless network router creates a unique network-device-router key. The unique network-device-router key is used to authenticate the network device for communicating over a wireless network using an encrypted network Session Key and allows encrypted link layer communication over the wireless network based on the network Session Key.

### BRIEF DESCRIPTION OF THE DRAWINGS

FIG. 1 illustrates a wireless sensor network in accordance with an exemplary embodiment of the invention.

FIG. 2 illustrates wireless routing utilizing the wireless sensor network of FIG. 1.

FIG. 3 is a leaf-node security state transition diagram of the wireless sensor network of FIG. 1 in accordance with an exemplary embodiment of the invention.

FIG. 4 is a sequence diagram of an installation of a Device Key into the leaf-node of FIG. 3 in accordance with an exemplary embodiment of the invention.

FIG. 5 is a sequence diagram of an installation of a Device Site Key into the leaf-node of FIG. 3 in accordance with an exemplary embodiment of the invention.

FIG. 6 is a sequence diagram of an installation of a Device Site Key into the leaf-node of FIG. 3 in accordance with an exemplary embodiment of the invention.

FIG. 7 is a sequence diagram of an installation of a Leaf Node Router Key in the leaf-node of FIG. 3 in accordance with an exemplary embodiment of the invention.

FIG. 8 is a sequence diagram of an updating of the Session Key in the leaf-node of FIG. 3 in accordance with an exemplary embodiment of the invention.

FIG. 9 is a sequence diagram of an updating of the Session Key of FIG. 8 in accordance with an exemplary embodiment of the invention.

FIG. 10 is a sequence diagram of a changing of the Session Key of FIG. 8 in accordance with an exemplary embodiment of the invention.

FIG. 11 is a sequence diagram of a detection of an invalid Session Key in accordance with an exemplary embodiment of the invention.

FIG. 12 is a sequence diagram of an implementation of a strong Heartbeat signal over the wireless network of FIG. 1 in accordance with an exemplary embodiment of the invention.

FIG. 13 is a sequence diagram of an implementation of a weak Heartbeat signal over the wireless network of FIG. 1 in accordance with an exemplary embodiment of the invention.

FIG. 14 is a sequence diagram of an initiation of a Software Update over the wireless network of FIG. 1 in accordance with an exemplary embodiment of the invention.

FIG. 15 illustrates a MAC Packet Format in accordance with an exemplary embodiment of the invention.

FIG. 16 illustrates a DATA Layer Encryption in accordance with an exemplary embodiment of the invention.

### DETAILED DESCRIPTION

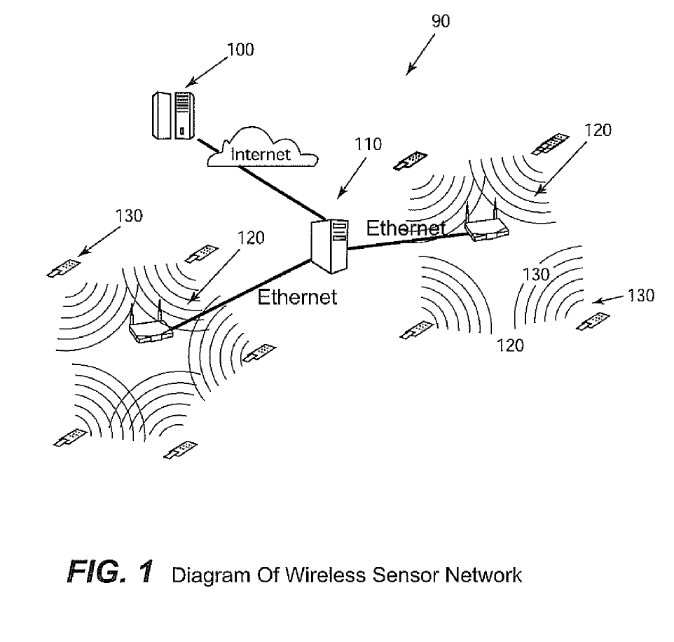

Described herein are systems and methods for providing security architecture having a secure framework for wireless sensor networks. The security architecture includes a wireless sensor network 90 shown in FIG. 1. As shown in, FIG. 1, the wireless sensor network 90 includes several components, some or all being of the off-the-shelf variety. Therefore, specialized equipment is not required, which reduces costs. For example, in an exemplary embodiment, the network 90 includes a backend server 100 that acts as the server at the manufacturer's support site that may be connected via, e.g., the Internet or other suitable network, such as a LAN or WAN. A gateway server 110, such as a general-purpose desktop computer with Ethernet capabilities and a physically secure interface (e.g. USB, Serial, IF, etc.) may also be included. The gateway server 110 acts as a control center to the wireless sensor network 90. The gateway server 110 also acts as a gateway to the customer's internal network or the Internet connected backend server 100, for example. A wireless network router 120 acts as a bridge between a plurality of leaf-nodes 130 and a wired network, provided, for example, by the gateway server 110. The wireless network router 120 has both wireless and wired (e.g. Ethernet-based, etc.) communication. The wireless network routers 120 run an embedded operating system that allows the devices to execute authentication algorithms. Each of these devices ultimately communicates with the plurality of leaf-nodes 130. Leaf nodes 130 are battery-powered sensors that are capable of wireless communication, similar to IEEE 802.15.4 compliant devices. The leaf-nodes 130 have other physical connections, such as USB, RS432, IR, etc. which can be used for initial set up and authentication key installation.

The leaf-nodes 130 and wireless network routers 120 may be off-the-shelf devices. The gateway server 110 may be a desktop computer system or server running various authentication programs for communicating with the wireless network router 120 and the leaf-nodes 130. The connection to the backend server 100 is optional, as some customer sites may not have Internet access.

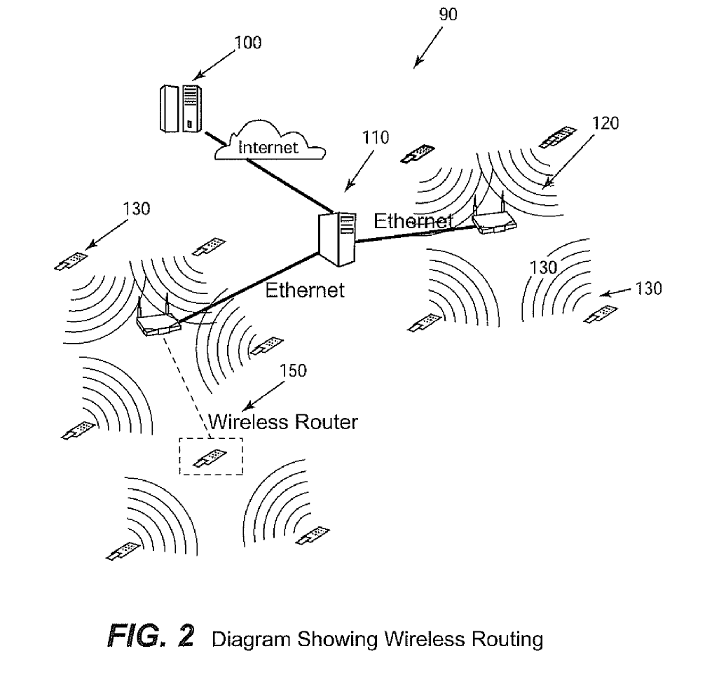

In exemplary embodiments, the leaf-nodes 130 may act as a router 120, which allow a wireless mesh network 150 to be established, as shown in FIG. 2.

The wireless sensors networks 90 shown in FIGS. 1 and 2 can be used in a wide variety of applications. Because there are risks involved with wireless networks, as the information can be eavesdropped, modified, falsified, and fabricated, authentication protocols for wireless devices in a network are necessary.

The leaf-node 130 is one of the most vulnerable links in the wireless network 90. It is somewhat limited in capability, being battery powered. Therefore, the mechanism the leaf-node 130 uses to authenticate itself to others and that it uses to authenticate others to itself is the major issue addressed in the embodiments described herein. In particular, the leaf-node 130 authenticates itself to the wireless network router 120 and vice versa. Oftentimes, the only link between the leaf-nodes 130 and the other components in the network 90 is the wireless link. The other major components, the wireless network router 120, gateway server 110 and back-end server 100, are hard wired devices that have other security frameworks in place.

In exemplary embodiments, the security architecture uses pair-wise encryption keys to authenticate devices. That is, when two devices wish to authenticate each other, they use a shared secret key that those two devices know. Only those devices know these key pairs, which they may share with each other over the gateway server 110. The gateway server 110 may then store all of the key pairs. In an exemplary example, the security architecture uses symmetric keys (where one key is shared between two or more systems). Because of the limitations of the leaf-nodes 130 in an exemplary embodiment, all keys used by the leaf-nodes 130 are based on the native support for encryption built into the off-the-self devices.

In exemplary embodiments, four different keys are used to authenticate a leaf-node 130 on the wireless sensor network 90. The architecture is designed so that if one of the keys is compromised, the damage is limited. In some cases the loss of security is limited to a single system rather than the whole network 90. When the loss is discovered, the key can be revoked, ensuring no loss of confidence in the integrity of the wireless sensor network 90.

The security protocol provides a way to install and transport keys, as well authenticates the devices. Each key has different life spans, and different ways to being installed in the leaf-node 130.

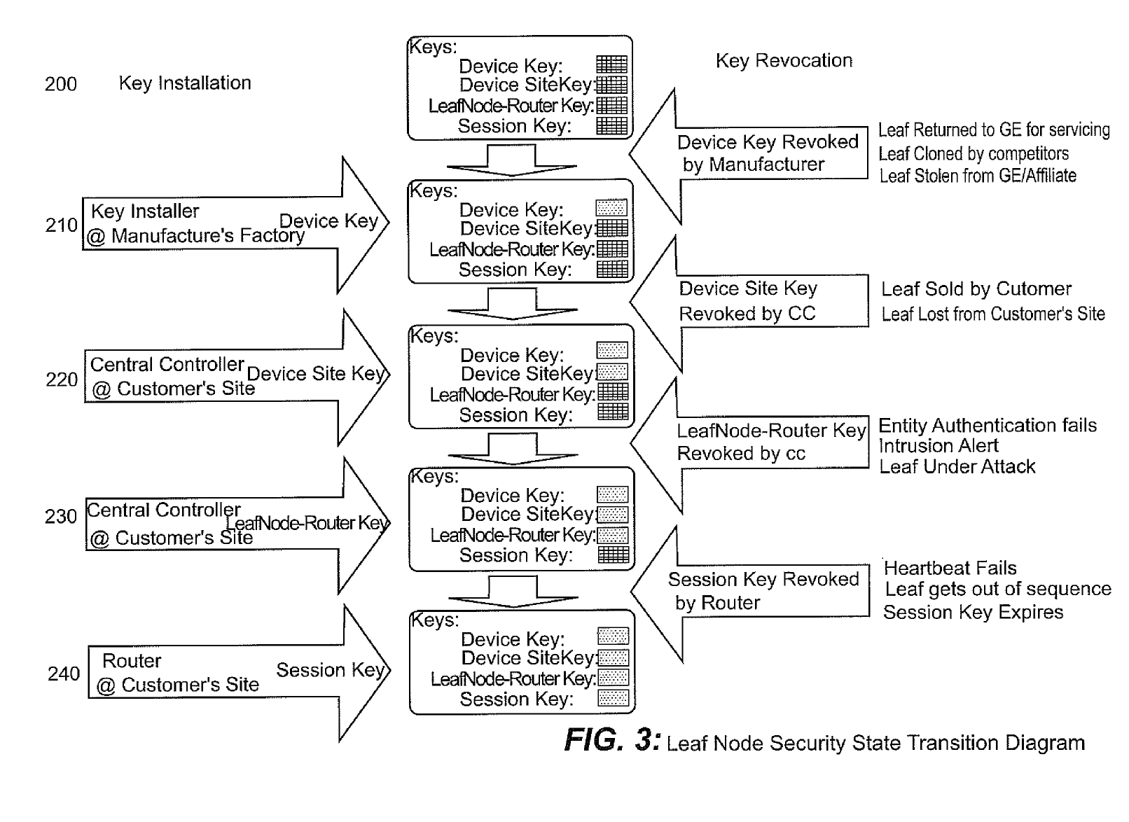

The leaf-node 130 has several different security states in its normal lifecycle. The diagram 200 in FIG. 3 shows the different states, or rather the progression involved in obtaining keys, by providing an overview of the changes the leaf-node 130 goes through as it obtains four keys. While the use of four keys is described, it should be understood that the number of keys can vary. There may be fewer than four keys or more than four keys. The actual implementation may have more states, as obtaining each key involves requests and responses. The five states shown in FIG. 3 define the privileges granted to the leaf-node 130.

The first state 210 begins when the leaf-node 130 is assembled in the factory. For example, at the manufacturing facility, a system connects to the leaf-node 130 as part of the final test. Soon after the leaf-node device 130 passes quality assurance (QA), a unique Device Key (DK) is created and stored in the leaf-node 130. The DK is a unique identification number or serial number. It may also be a unique media access control (MAC) address. After the last step in the manufacturing process, the leaf-node device 130 only has one key stored in memory. Ideally, no two leaf-nodes 130 will have the same DK. The first state 210 can also occur after a command to reset the firmware of the leaf-node device 130 to the initial state (as part of the decommission state). In an alternative embodiment, there may be one or more second device keys, which are created and installed by the customer. As the leaf-node 130 is installed in the network 90, the DK is also stored in the gateway server 110.

Wireless connections can be eavesdropped upon; therefore, man-in-the-middle attacks are possible. As an example, consider two identical devices using the same wireless network 90; there is typically no way to distinguish between these two identical leaf-nodes 130. DKs are installed in the devices ideally using a physically secured channel to ensure they are not copied and to distinguish the leaf-nodes 130 over the wireless network 90.

The DK is designed to be unique so that no two leaf-nodes 130 have the same DK. Ideally, a cryptographically strong random number generator is used to create the DK. As part of the installation, the random number generator also creates non-repeatable values called a nonce. The nonce could be a random number, a timestamp, or a monotonically increasing number. The nonce is used both to prevent old numbers from being repeated and to prevent replay attacks. In one embodiment, the DK is created using a nonce.

The customer has a mechanism to obtain the DK, without interception by others. For example, the DK might be obtained from the manufacture via a secure communication, via a CDROM, printout, etc. Also, as the device becomes more personalized by the customer, additional keys may be installed in the leaf-node 130 using the previous keys. These keys can come from one or more backend servers (sometimes called the Key Authority or the Key Distribution Centers) and are installed on the leaf-nodes 130. In general, lower (or earlier installed) keys are more valuable, but less localized. Once a key is installed, a lower (or earlier) key is required to update/refresh any new keys.

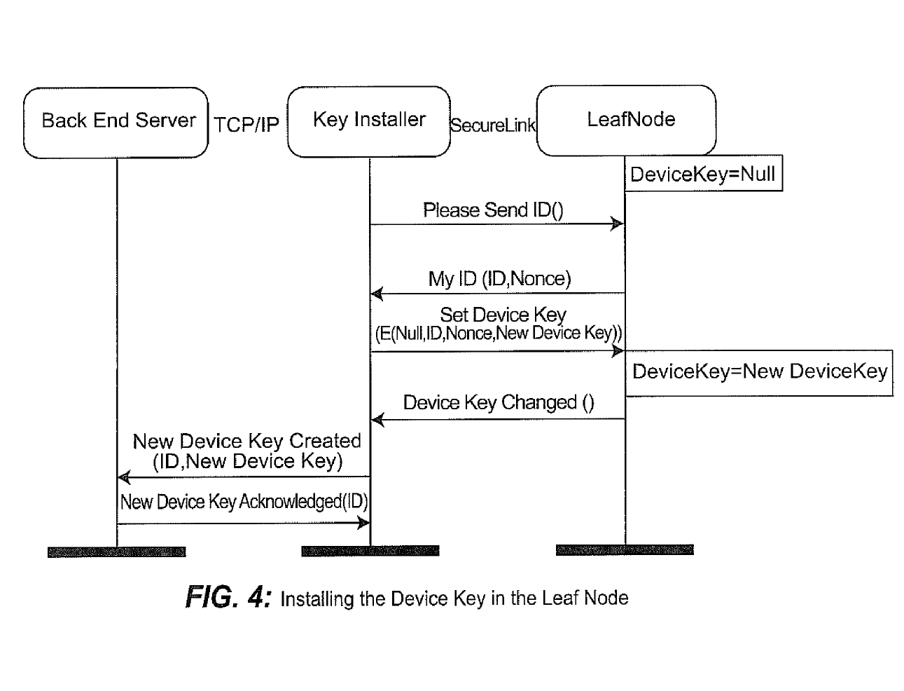

The sequence for installing the DK is described in FIG. 4. The communication link to the leaf-node 130 is by physically secure connection. The communication to the backend server 100 may be via TCP/IP or some other Ethernet protocol. This physically secure link is used to communicate with the leaf-node 130 for this step. When the firmware is installed in the leaf-node 130, the DK might have a predetermined and known value. As shown in FIG. 4, the encrypted message in the third sequence (SetDeviceKey) is encrypted with this predetermined key (Null), which gives the leaf-node 130 a unique DK. This predetermined key may have the value of all zero or null, as an example.

The key is installed using a physically secure link (such as Serial, USB, or Infrared, ideally a communication channel that protects the data from eavesdropping). The leaf-node 130 does not ever expose the DK in a plaintext (unencrypted) form over the secure interface. Therefore if the communication data was observed, the new DK would still be encrypted. In an exemplary embodiment, once the DK has been set, it cannot be changed using the physically secure interface, this prevents someone from reassigning and reusing the existing device with a new DK. Therefore, if a used leaf-node 130 is obtained, it cannot be used unless the DK is also obtained from the owner or manufacturer. This prevents the selling of stolen leaf-nodes 130 and ensures that all leaf-nodes 130 use the manufacturer's keys. This process also ensures the firmware of the leaf-nodes 130 remains unmodified.

The DK is designed to be unique and permanent. The firmware in the leaf-node 130 inhibits unauthorized persons from changing the DK. However, the device manufacturer may change the DK during firmware updates or under other conditions. In another embodiment, the vendor may provide a second DK, installed using the first DK. The secondary DK may have an expiration period. Therefore, the second key may have to be refreshed periodically by using the first DK.

As shown in the diagram in FIG. 3, the second state 220 occurs once the leaf-nodes 130 arrive at the customer site. Here, the leaf-nodes 130 are commissioned. Ideally, the customer uses a physically secure connection to install a Device Site Key (DSK). The leaf-node 130 may be attached the gateway server 110 over a physically secure channel to install the DSK. During the install process, the customer first generates an encrypted request using a nonce. The gateway server 110 responds to the leaf-node 130 with a response encrypted with the DK and the nonce. The leaf-node 130 then uses the DK to decrypt the response. If the nonce generated by the customer is contained inside the decrypted packet, the leaf-node 130 acknowledges the gateway server 110 has provided the DK, and allows a new key, the DSK, to be installed in the leaf-node 130. The customer verifies that the new DSK was accepted by obtaining as a result, the nonce the customer previously generated. The DSK is also stored in the gateway server 110. Note that a third party could act as a proxy of middle-man in this process, and the DSK and DK may be unknown to the third party.

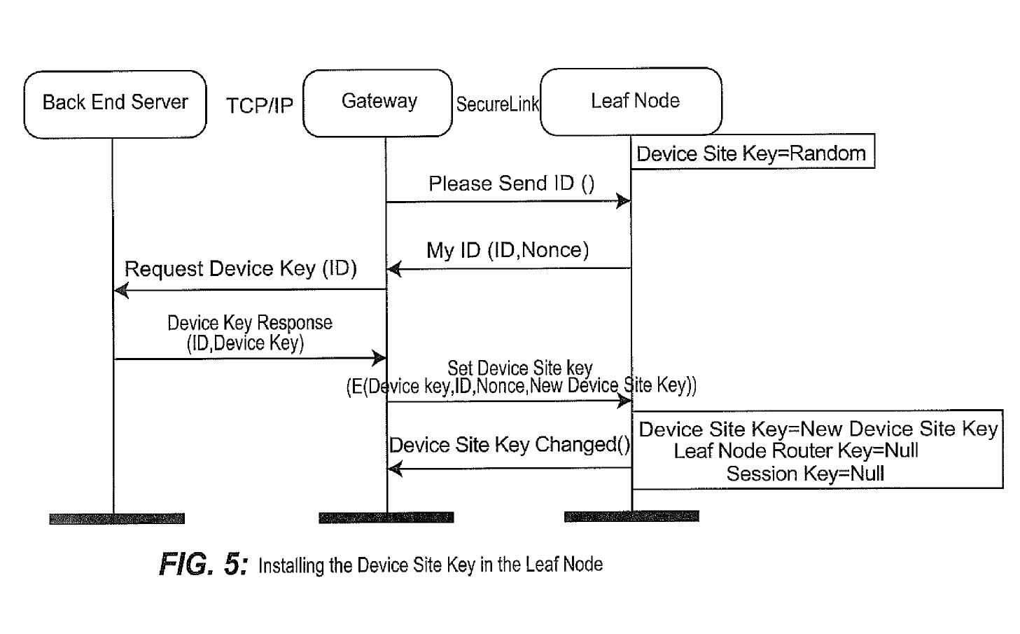

FIG. 5 provides a diagram of the sequence for installing a DSK in a leaf-node 130 when the customer knows DK. The leaf-node 130 DSK is changed ideally using the physically secure port and not the wireless port. The example shown in FIG. 5 is used where the leaf-node 130 has been decommissioned or sold to a third party. In this diagram, it is assumed that the gateway server 110 obtained the DK from a backend server 100 using an encrypted link. The key may also be obtained from a CDROM, printed label, e-mail, etc. The backend server 100 may also be a copy of the database or be a proxy on the network 90 that connects to the gateway server 110.

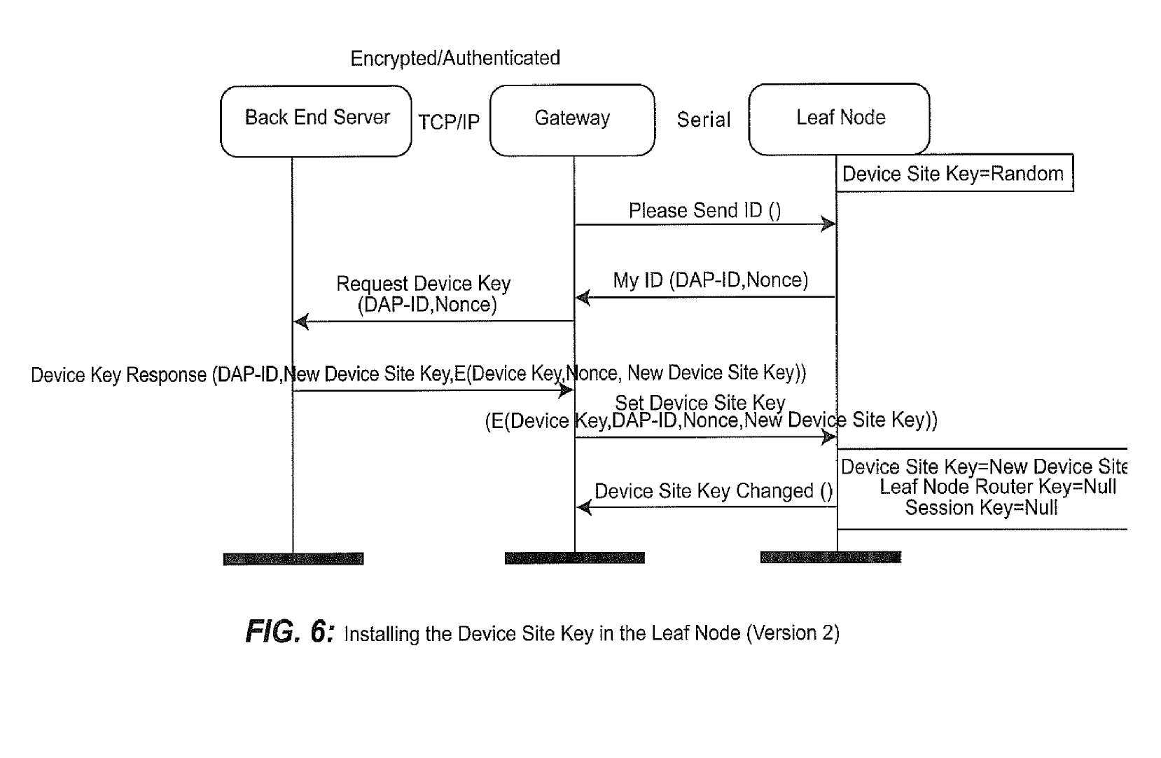

FIG. 6 provides an alternative embodiment of the sequence for installing the DSK. This variation may be used when the manufacture does not wish the customer to know the DK. This variation further reduces the risk of stolen sensors from being used, because the attacker must also steal the DK. A second nonce (Nonce2) is used to verify the successful installation of a new key. The same process could be used to install a secondary DK using the primary DK, allowing the customer to refresh a key that has or will expire. The proxy in this case may be one or more devices that relay the information. The customer can use this same process to install additional keys into the device. The key installer system may be owned by the vendor or by the customer.

The gateway server 110 is essentially the “keeper” of the customer keys. Therefore, the gateway server 110 can revoke the DSK of any leaf-node 130 at any time for various reasons. For example, the gateway server 110 may explicitly revoke the key to address a threat, such as direct attack on the device. The leaf-node 130 may also be decommissioned. Decommissioning of the leaf-node 130 may be temporary or permanent. If the decommission is permanent, the DSK can be erased on the gateway server 110 and optionally on the leaf-node 130. The leaf-node's 130 DSK may also be revoked if the leaf-node 130 has been engaged in unauthorized or suspicious behavior. Further, the leaf-node's 130 DSK may be revoked if the leaf-node 130 fails to communicate with the network 90 within a specified time period. The DSK is usually installed using the physically secure link rather than the wireless link. However, the DSK may be revoked over the wireless link. The gateway server 110 may also store additional information about the DSK for a specific leaf-node 130, such as the locations, networks, buildings, etc., to which the leaf-node 130 is allowed to connect to.

In an exemplary embodiment, as shown in the diagram in FIG. 3, the third state 230 of the security protocol allows the leaf-node 130 to communicate with the wireless router 120. Before the leaf-node 130 connects to the wireless router 120 it must discover any within its range. Next, the leaf-node 130 asks the within-range wireless routers 120 for authorization to connect to their network 90. In an exemplary implementation, the leaf-node 130 obtains a key from the gateway server 110, yet cannot directly communicate to the gateway server 110 because it is no longer physically connected to the gateway server 110 at this point. Therefore, it sends a request to the wireless router 120, at which time the wireless router 120 communicates to the gateway server 110 to verify the identify of the leaf-node 130. The gateway server 110 determines the identification of the device by receiving an encrypted packet from the leaf-node 130 and wireless router 120 containing the leaf-node's 130 DK and DSK. It then decodes the packet transmitted by the leaf-node 130 using the encryption key DSK to authenticate the device, as the decrypted packet also contains the DK. Based on this information the gateway server 110 responds with an authorization whether to allow the wireless router 120 to link with the leaf-node 130. The wireless router 120 receives information from the gateway server 110, authenticates the transmission and determines if the gateway server 110 has authorized the connection between the leaf-node 130 and the wireless router 120. If the gateway server 110 has granted permission, it creates an encrypted Bootstrap Key (BK, also called a Leaf-node Router Key) to be used to set up a secure link between the leaf-node 130 and the wireless router 120. The BK is encrypted first in a key known to the wireless router 120, and second in a key known to the leaf-node 130. The nonces and the identification tags of the systems involved are included in the encrypted data so that the receiver can verify the contents. The wireless router 120 forwards encrypted information to the leaf-node 130. It also receives an encrypted BK from the gateway server 110, which the wireless router 120 uses to authenticate the leaf-node 130. The BK is saved in the wireless router 120 so that is it not required to authenticate that particular leaf-node 130 in the immediate future. By storing this key, a re-join request can occur without requiring permission from the gateway server 110, thus improving scalability. The BK can be set to expire after a certain amount of time as elapsed.

Each leaf-node 130 BK pair is unique. Only three entities at each site have knowledge of this key, including for example, the gateway server 110, the wireless network router 120 and the leaf-node 130. The gateway server 110 can revoke the BK and can communicate this revocation to the wireless router 120. This process effectively revoking the secure link between the leaf-node 130 and the wireless router 120, which may occur under the same conditions as when the DSK is revoked or disabled.

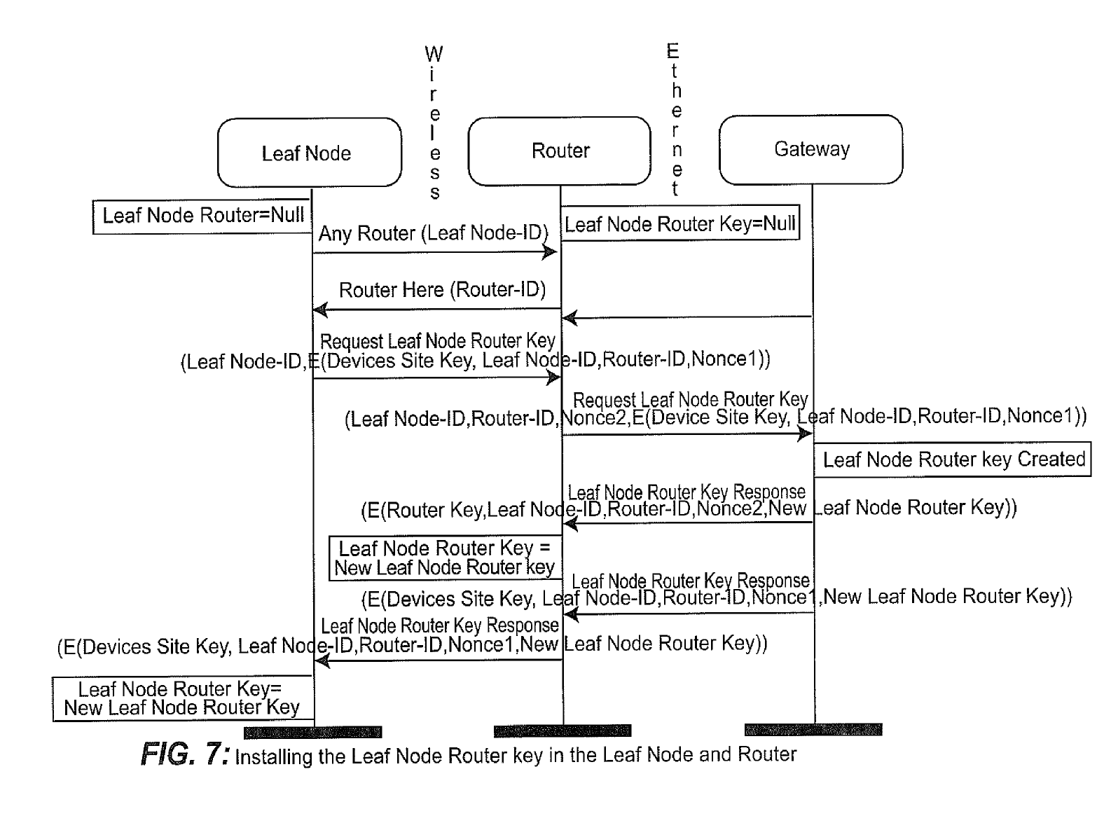

The diagram in FIG. 7 discloses the message sequence for establishing the connection between the leaf-node 130 and router 120. The leaf-node 130 communicates wirelessly with the wireless network router 120. Therefore, the router 120 acts as an un-trusted middleman and forwards a connection authorization request to the gateway server 110 as explained above.

If the wireless router 120 is used as a mesh router 150 as shown in FIG. 2, then the second interface occurs wirelessly instead of via an Ethernet connection. However, the protocol remains the same. In a mesh router network 150, a leaf-node 130 acts as if it were a router 120. However, this leaf-node 130 acting as a router 120 initially behaves like a leaf-node 130 and asks for a BK from another router 120. Once the leaf-node 130 acting as a router 120 has the BK, it can act as a router 120 to other leaf-nodes 130.

Referring to FIG. 7, note there are two encrypted blocks of data in the BK packet (also called LeafNodeRouterKeyResponse). The router 120 can decrypt the first one, which is encrypted with a key the router 120 knows (RouterKey). The second block of data is forwarded encrypted to the leaf-node 130, which uses the DSK to decrypt it when it arrives.

Also note, the BK is transmitted to the router 120 encrypted using a RouterKey, which is a shared key known to the gateway server 110 and the router 120. If a secure TCP/IP communication channel is used, then another form of encryption could be used, including trusting the link-layer encryption was sufficient.

Once the authenticated link between the leaf-node 130 and the wireless router 120 is established, the devices are enabled to communicate with each other. However, the devices are not able to communicate using link layer encryption. Therefore, as shown in the diagram in FIG. 3, in the fourth state 240 of the security protocol, the leaf-node 130 sends a packet request to the wireless router 120 for a Session Key (SK) or Link-Layer key. The packet request includes the BK for authentication. Once the BK is verified, the wireless router 120 responds with a SK that is stored in an encryption register of the gateway server 110. The leaf-node 130 gets the new SK. Once the SK is issued, in the exemplary embodiment, all major states (states 210 thru 240) are operational and secure communications may flow wirelessly between the leaf-node 130 and other network devices. However, the SK may change periodically or dynamically depending on the needs of the system.

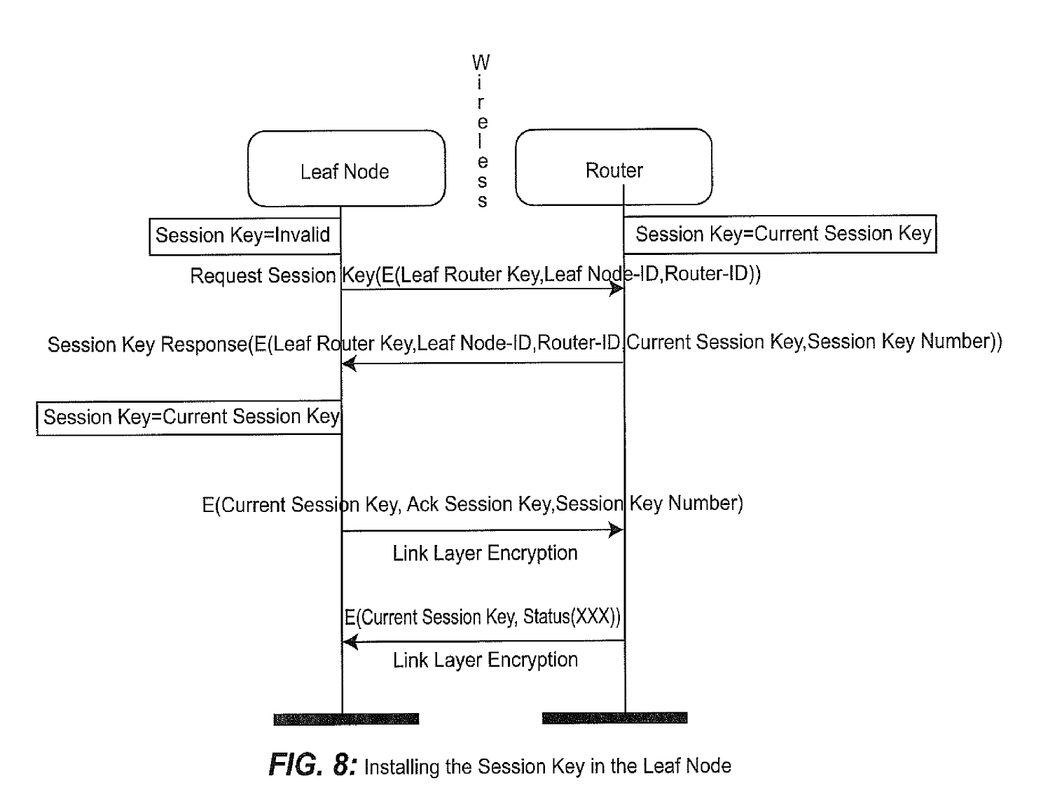

The SK sequence, shown in FIG. 8, may add complexity to the security protocols, in order to add flexibility at the implementation layer. In one exemplary implementation, a single SK shared by all devices communicating with the router 120, also allows various leaf-nodes 130 to communicate directly with each other. In other exemplary implementations, separate SKs are used for each device. This architecture will support both.

Also, several SKs may be pre-stored in the leaf-nodes 130 before being used, to allow quick SK changes. For example, the wireless router 120 may broadcast the SK changes wirelessly. However, some leaf-nodes 130 may be asleep to conserve power. In such cases, the radio is turned off. Therefore, the SK cannot be updated until the leaf-node 130 wakes up and the wireless router 120 transmits the new SK to the leaf-node 130. To prevent a delay however, the pre-stored SKs allow the leaf-nodes 130 to communicate with the network 90 once the leaf-nodes 130 awake and become active.

In addition, the system can exclude a device from getting a SK update. For instance, if a device is under attack, it may be desirable to change the SK for all devices except the one under attack. The use of multiple SKs may allow the router 120 to act as a “honeypot” device by feeding wrong information to the leaf-node 130 that is under attack.

In one embodiment, the design uses SKs with corresponding SK numbers. The SK numbers are used to identify different keys without requiring transmission of the full SK. In one implementation, the SK number is two (2) bytes and the full SK is sixteen (16) bytes. The number of bytes may vary by application, however.

In general, the SK is installed over the radio link using the message sequence shown in FIG. 8 and using information encrypted at the application layer. The response is also encrypted at the link layer using the new SK. The status code contained in the E(CurrentSessionKey,Status(XXX)) packet shown in FIG. 8 may contain data that tells the leaf-node 130 that additional SK values and numbers are available and should be obtained.

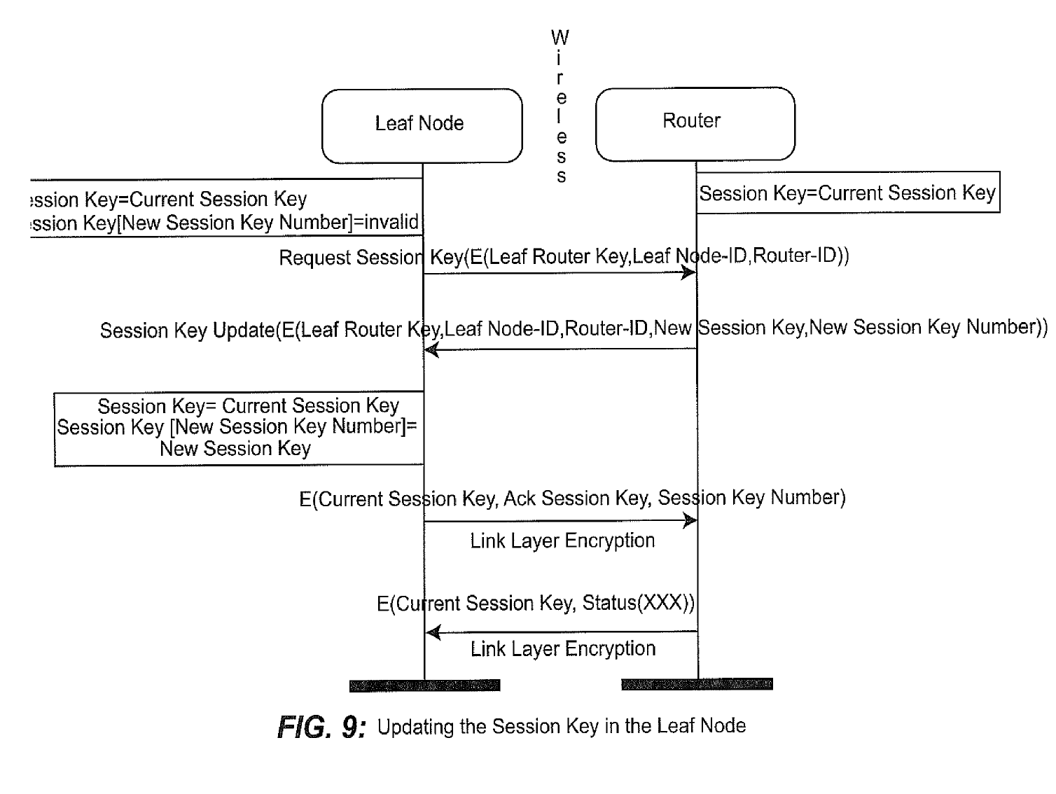

The SK update is (or can be) identical to the SK installation request, with the exception that the wireless router 120 responds to the SK request from the leaf-node 130 with the Session Key Update packet SessionKeyUpdate(E(LeafRouterKey,LeafNode-ID,Router-ID,NewSessionKey, NewSessionKeyNumber)), which contains the new SK and SK number as shown in the diagram in FIG. 9. In other words, the leaf-node 130 requests a SK if either it has no SK or if it knows (by way of the values of the status command) that there is a new SK that is coming up. The router 120 keeps track of the SK and SK numbers that the leaf-node 130 has acknowledged. As long as there are unacknowledged SKs, the router 120 can send them to the leaf-node 130.

Included in the encrypted packet is a SK number, which allows the wireless router 120 to send several keys to the leaf-node 130 for storage ahead of time. It also waits for the leaf-node 130 to acknowledge the SK reception. A SK update response may not change the current SK.

If the router 120 has no more SK pairs to send, it can respond to the requested SK packet with either a status packet (if the leaf-node 130 already knows the current SK) or with the SK response (which sends the current SK again).

The architecture allows the router 120 to broadcast a packet to all leaf-nodes 130 to change SKs to a new number. Alternatively, the design allows the router 120 to change SKs for leaf-nodes 130 individually. For example, as shown in FIG. 9, the response to a request for a new SK returns the packet containing SessionKeyUpdate as described above. This packet contains the LeafRoutherKey (the BK), leaf-node identification and router identification. Therefore, any device that knows the current SK will not automatically know the new SK. The router 120 can therefore exclude other unidentified leaf-nodes 130 by updating the SK, which effectively isolates the excluded leaf-nodes 130.

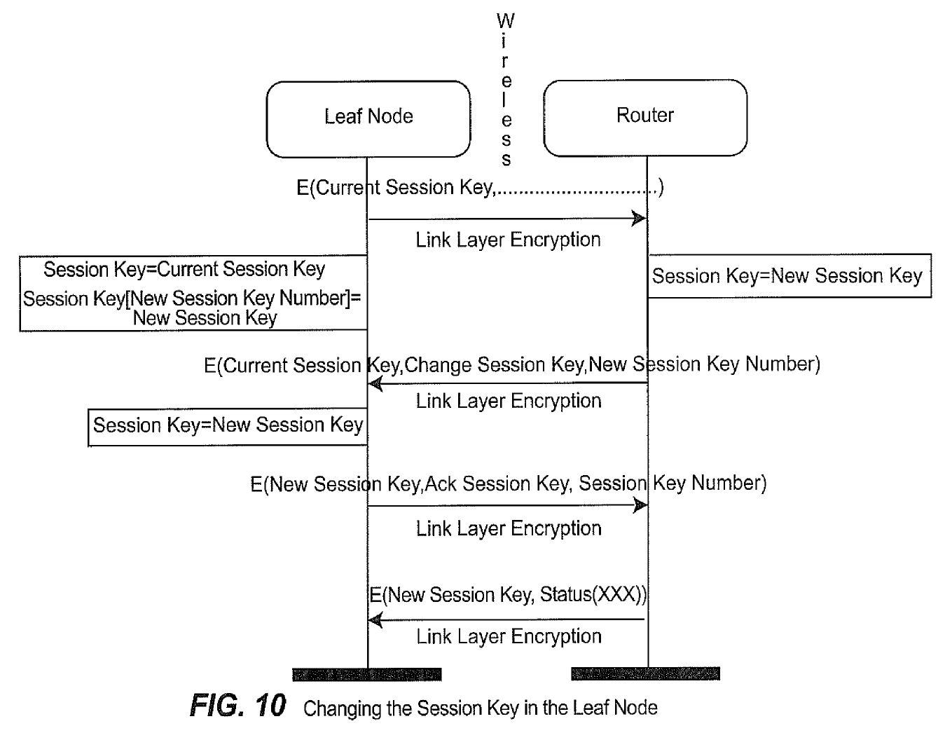

In one embodiment, the SK change is accomplished using link layer encryption as shown in the E(NewSessionKey,AckSessionKey,SessionKeyNumber) packet presented in FIG. 10. In this sequence the router 120 responds to the leaf-node 130 with a packet that instructs the leaf-node 130 to switch to a new SK. Any packet may trigger this response, however in one embodiment, the implementation is restricted to a particular subset of packets. The first SK change is done using the current SK and the response is completed using the new SK.

Note however, as shown in FIG. 10, the response to a request for a new SK returns the packet E(CurrentSessionKey, ChangeSessionKey, NewSessionKeyNumber). Therefore, the new SK number is transmitted rather than the new full SK. In this embodiment, the new SK is also transmitted using link-layer encryption, but without using the BK.

It is possible to quickly change Session Keys up to the number of keys previously stored in the leaf-node 130. It also enables the wireless router 120 to skip one of the SKs in case one of the leaf-nodes 130 did not acknowledge receiving it. The router 120 can use other mechanisms to install different SKs and key numbers in the leaf-nodes 130, and choose which is the best SK to use.

The router 120 can also pre-install several SKs. That is, each leaf-node 130 has at least one “spare/unused” SK when a second SK is installed. Suppose the leaf-nodes 130 are using SK-A, and the next is SK-B. The router 120 could be in the middle of updating all the SKs to SK-C, when it is interrupted with a requirement to update all SKs immediately. It cannot change all SKs to SK-C because not all leaf-nodes 130 have acknowledged receiving this key. Therefore, it would have to update all leaf-nodes 130 to SK-B and then install SK-C on the remaining leaf-nodes 130. If a leaf-node 130 is not able to switch to SK-B (or the new SK), it can request one from the wireless router 120 using one of the previously described SK install sequences.

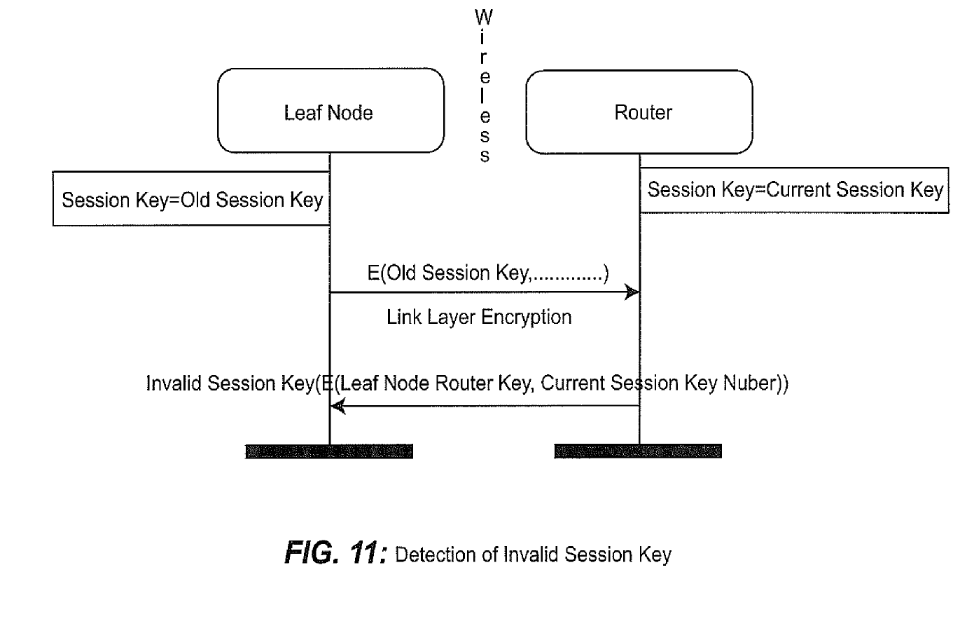

The sequence shown in FIG. 11 describes a process for detecting an invalid SK. When a leaf-node 130 transmits a package using a SK that the wireless router 120 does not recognize, the router 120 considers the SK to be invalid. It sends a response to the leaf-node 130 that the SK is invalid, as shown in FIG. 11. The response from the router 120 is encrypted using the LeafNodeRouterKey (the BK), but not encrypted at the link layer level. This allows a quick recovery if the leaf-node 130 is using an invalid SK. The leaf-node 130 can either use another SK that it has already been received or it can request a new SK.

The protocol sequence described above prevents a compromised leaf-node 130 from learning a new SK. Therefore, the router 120 sends new SKs to all of the other leaf-nodes 130 except for the one compromised. The compromised leaf-node 130 is not updated with the new SK. Any SKs previously stored in the leaf-nodes 130 are deleted and the router 120 creates new SKs and updates all uncompromised leaf-nodes 130 with the new SKs. Alternatively, the router 120 revokes the SK for all leaf-nodes 130, forcing each leaf-node 130 to initiate a sequence to obtain a new SK. In exemplary embodiments, the wireless network router 120 and leaf-node 130 periodically query each other to make sure the other device is still listening on the network 90. If the devices are unable to communicate, the leaf-node 130 is disconnected from the network 90. If this happens for an extended period of time, the leaf-node 130 may have to re-authenticate itself, perhaps even to a different wireless router 120. Every key the leaf-node 130 has, except for the DK, may be revoked if the leaf-node 130 has been disconnected for longer than the valid timeout period set by the system administrator.

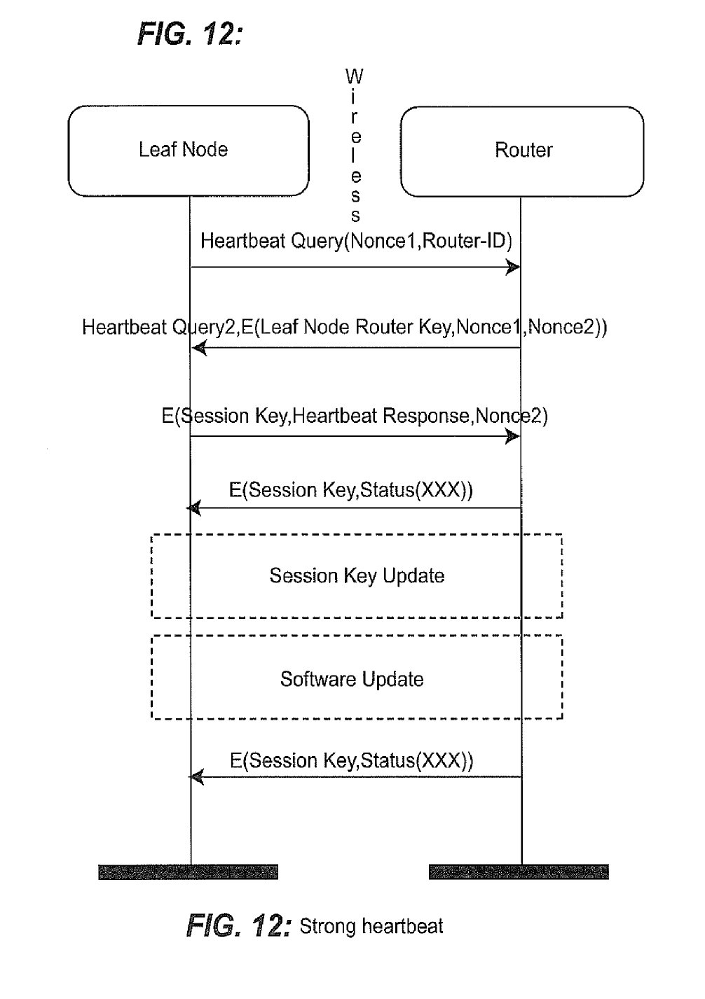

The sequence shown in FIG. 12 describes the process used to verify that a leaf-node device 130 is still attached to the network 90. The process uses very few encryption request/response sequences in order to preserve battery power. The leaf-node 130 must initiate the sequence because the leaf-node 130 only listens when it is awake. The status packet, E(SessionKey,Status(XXX)), is sent from the router 120 to the leaf-node 130 and indicates if there are actions the leaf-node 130 is to take, such as request a new SK or software update. If the status indicates nothing needs to be done, the leaf-node 130 can sleep until the next event or heartbeat.

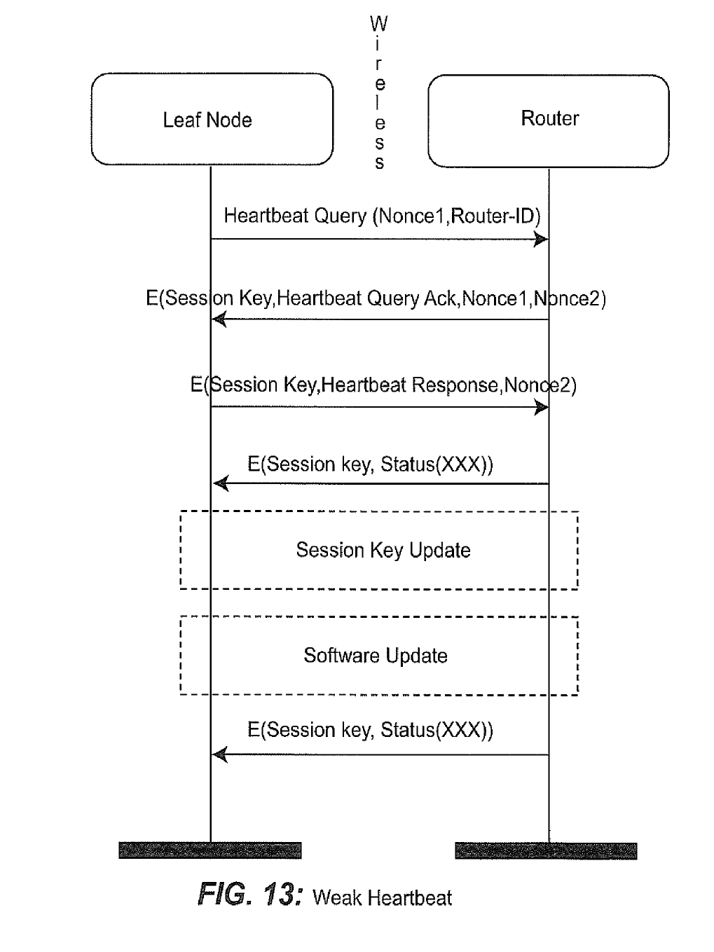

In an alternative embodiment, the heartbeat sequence shown in FIG. 13 describes a process when the heartbeat signal is weak. In exemplary embodiments processes having a weak heartbeat signal may be used in order to further conserve battery power. While the previous process describes a strong heartbeat signal that sends responses back encrypted with the LeafNodeRouterKey (the BK), the process for the weak heart beat signal is different. The process for the weak heartbeat signals send a message encrypted with the SK. The process for the weak heartbeat signal may also be desirable if separate SKs are used for each router 120 to leaf-node 130 link. This allows the system to provide a similar level of security while conserving battery life.

Further in exemplary embodiments, if the leaf-node 130 has timed out for an extended period, the leaf-node 130 may be decommissioned. When decommissioning occurs, all keys of the leaf-node 130 are invalidated except the DK. In exemplary embodiments, this is what may occur if the gateway server 110 revokes all the keys used at a particular site. The gateway server 110 may also revoke all keys associated with a particular leaf-node 130 if the leaf-node 130 appears to be missing for a specific period of time. The leaf-node 130 may still contain the keys, however they may be invalidated at both the gateway server 110 and the wireless router 120.

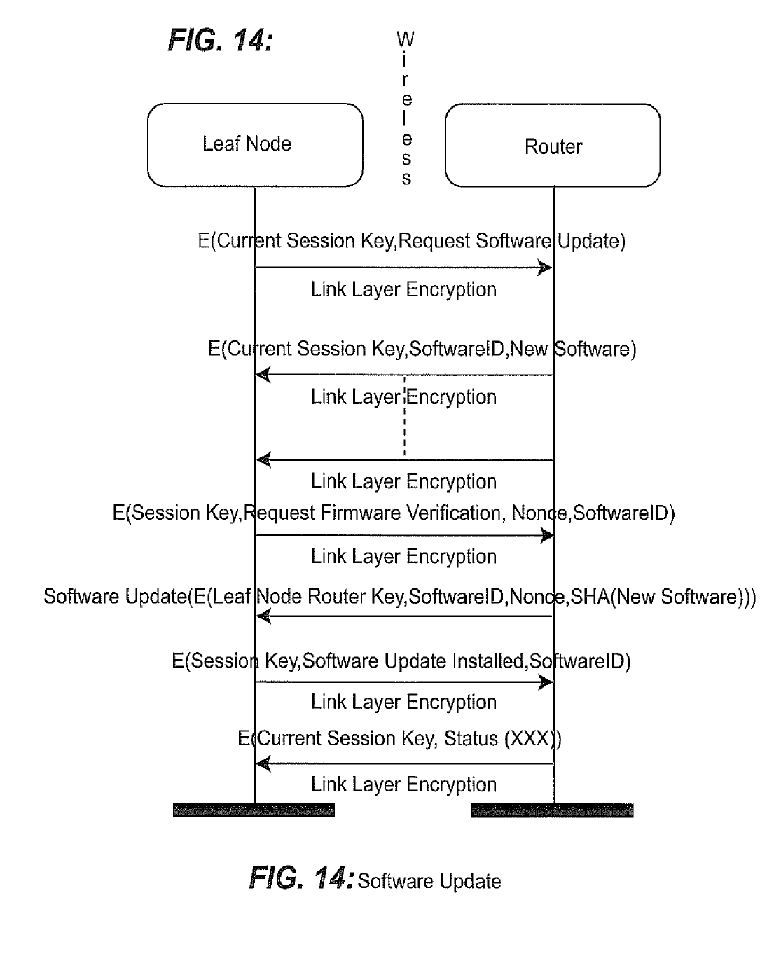

Physically connecting the leaf-nodes 130 to the gateway server 110 and performing a firmware reset also may also be used to decommission the leaf-nodes 130. This process erases all keys within the leaf-nodes 130 except the DK set by the manufacture. This allows the leaf-nodes 130 to be restored back to their original state 210, shown in FIG. 3., before the customer installed leaf-nodes 130 into the wireless network. In this state, each leaf-node 130 may be resold or used by another customer. Periodically the firmware in the leaf-nodes 130 may require updating. The sequence shown in FIG. 14 describes a process wherein a software update may be transmitted using link layer encryption. When a leaf-node 130 requests a software update, a hash value (SoftwareID) based on the LeafNodeRouterKey (the BK) is calculated for the software and transmitted to the leaf-node 130. The leaf-node 130 responds to with a firmware request verification containing the SoftwareID. Once the software ID is verified, the software update is installed on the leaf-node 130. Since only the leaf-node 130 and router 120 knows LeafNodeRouterKey (the BK), the software must come from the wireless router 120.

The discussion above provides an overview of the communication links between the hardware devices. However, the architecture uses several means of data encryption. The process and method of encryption is discussed in detail below.

The process provides encryption security using existing and readily available encryption hardware. In the exemplary embodiment, an IEEE 802.15.4 wireless personal area network standard is used. The 802.15.4 packets support several MAC (Media Access Control)-layer (or link layer) encryption and authentication schemes. In one embodiment a Chipcon® CC2420 radio, utilizing hardware-based AES-CCM-128 for both data-layer and MAC encryption and authentication is used.

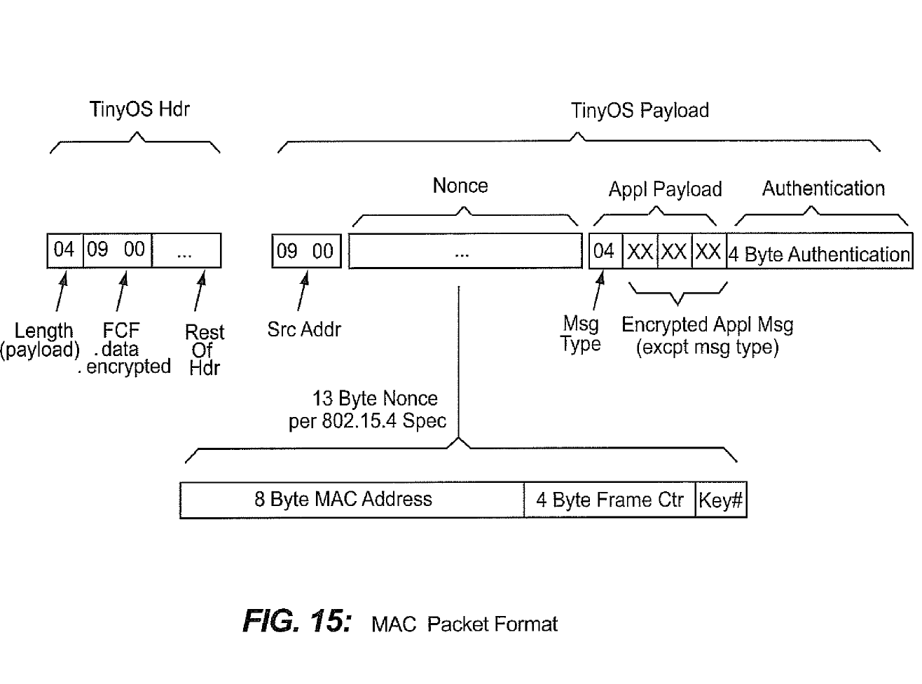

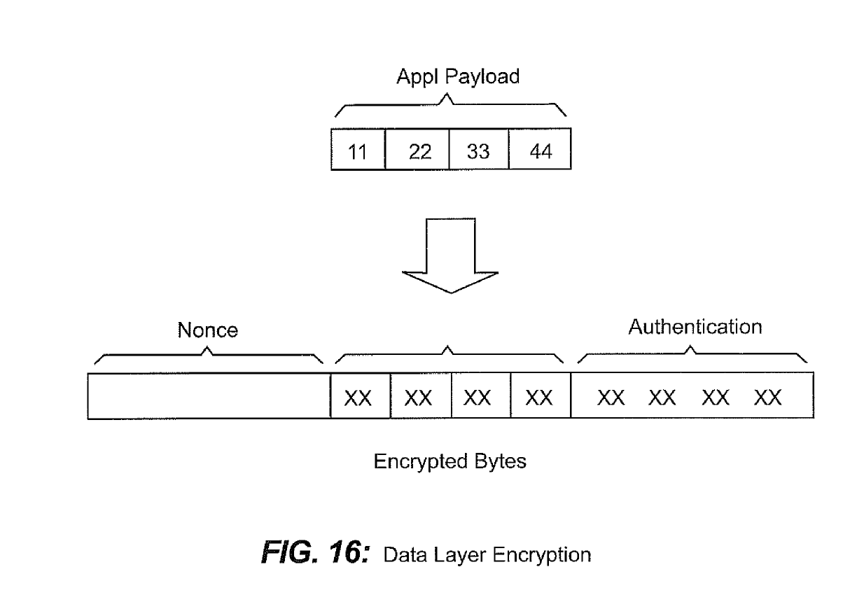

In exemplary embodiments, the development environment used TinyOS® to implement the algorithms. The packet format for transmitting the MAC address is shown in FIG. 15. The algorithms in TinyOS® automatically updates the data sequence number in the header. In addition, a monotonically increasing number for a 4-byte frame counter is used. The data-layer encryption structure is shown in FIG. 16.

The generation of a nonce value can be the same source as the MAC-layer nonce. That is, the same monotonically increasing value can be used. This simplifies the detection of replay attacks by the sensor.

In discussing the encryption technologies, the following terminology is used: leaf-node sensors (S) with unique identifier (I_{S}) communicates to authorities (A) to obtain keys (K). Encrypted messages are indicated by { . . . }K.

Authentication is based on paired symmetric keys, where only two devices use the key to authenticate each other. The generalized key installation is shown in these three steps.
(1) S→A: I_{S}, N₁
(2) A→S: {I_{S}, N₁, N₂, K_{N+1}}K_{N}
(3) S→A: N2

Key K_{N} is therefore used to install key K_{N+1}. As explained below, the encryption scheme is based upon the use of key chains. Each subsequent key is encrypted using the previous key, such that K0→K1→K2→K3→ . . . KN (or K_{V}→K_{S}→K_{bootstrap}→K_{MAC}). The sensor verifies the key validity by checking the identification number and nonce within the encrypted response matches. The nonces N₁, N₂ are used to prevent replay attacks.

In exemplary embodiments, the communication channel need not be secure because data-layer encryption is used. However, if the channel allows multiple leaf-node devices 130, care has to be taken to ensure the leaf-node device 130 identification matches the device being initialized. Relays can be used to install keys. Nonce N₂ is used to confirm the device received the proper key. Nonce lifetime is sufficient to allow for long-latency authentication, which allows a form of off-line authentication.

The knowledge of K_{N} beforehand is the primary threat in this approach. Nonce predictability is an issue for the authority A in step 3, which is prevented by a cryptographically strong random number generator (RNG). The nonce for the leaf-nodes 130 is a potential problem. Trusted timestamps and RNG's require additional resources that may not be available in a leaf-node 130; therefore it is assumed that leaf-nodes 130 use a monotonically increasing number, and authentication devices that validate these numbers remember the last number used for each leaf-node 130. The symbol “→” indicates the transmission of a packet without MAC encryption, and “ [symbol] ” indicates MAC encryption as a visual aid.

There are advantages to making this key installation mechanism generalized. While the exemplary embodiments above disclose a process with only four keys for the framework, two (or more) additional keys may be added to allow greater flexibility, as described below.

The leaf-node manufacturing facility produces nearly identical leaf-node devices 130, installing a common key K₀ (=Null) into the firmware, while also installing a unique identification (DK) into the device. A key installation mechanism installs a unique key K₁ (=DK) into the device. As K₀ is known, this must be a private and secured communication channel:
(4) S→A: I_{S}, N₁
(5) A→S: {I_{S}, N₁, N₂, K₁}K₀
(6) S→A: N2

The K₁ can, if the vendor desires, be used to install a secondary vendor key K₂. Key K₂ can be constructed to expire after a period of time.

When the customer receives the leaf-node 130, and obtains the identification, it obtains a key K_{V} from the vendor. Depending upon the implementation, K_{V} can be K₁ or K₂. There are several mechanisms that can be used to obtain the key, such as a CD-ROM, a web server, tear-off labels, etc. The vendor can revoke keys based on I_{S}in the case of stolen or cloned devices by refusing to tell the customer the key. The vendor can verify the identity of the device by examining N₂. If K_{V} is K₂, the key can be designed to expire after a certain time period to force the customer to refresh the key. If K_{V} is K₁, once that key is obtained, the customer does not need to use the vendor services to enable the leaf-node device 130 in the future.

The customer then installs the unique-per-device site key K_{S}.
(7) S→A: I_{S}, N₁
(8) A→S: {I_{S}, N₁, N₂, K_{S}}K_{V}
(9) S→A: N₂

And can optionally install an end-to-end authenticity key K_{A}.
(10) S→A: I_{S}, N₃
(11) A→S: {I_{S}, N₃, N₄, K_{A}}K_{S}
(12) S→A: N₄

Battery-conserving leaf-node devices 130 typically “sleep”—with their radios disabled. Therefore, the leaf-node sensor 130 initiates all wireless protocol sequences described below. Protocol sequences typically end with a status packet from the router 120 to a leaf-node 130, which identifies pending sequences.

A leaf-node 130 joining the network 90 for the first time needs to locate and verify the identity of the nearest router 120. The router 120 has already been authenticated for the network 90, and has its own key K_{Router} (RouterKey) known to the site authority. A two-phase sequence is used to obtain the MAC key. The first sequence obtains the bootstrap key K_{Bootstrap} (BootstrapKey).
(13) S→Broadcast:
(14) R→S: I_{R}
(15) S→R: I_{S}, {I_{S}, I_{R}, N₁}K_{V}
(16) R→A: {I_{R}, I_{S}, N₂, {I_{S}, I_{R}, N₁}K_{V}}K_{Router}
(17) A→R: {K_{Bootstrap}, I_{R}, I_{S}, N₂} K_{Router}+{K_{Bootstrap}, I_{S}, I_{R}, N₁}K_{V}
(18) R→S: {K_{Bootstrap}, I_{S}, I_{R}, N₁}K_{V}

This sequence enables the site authority to create and install a new bootstrap key that enables the router 120 and leaf-node sensor 130 to authenticate each other. Note that the message in (15) is opaque to the router 120, which forwards the request for a BK to the site authority for authentication in (16). The site authority returns two encrypted messages in (17) and the router 120 forwards one of these to the leaf-node 130 in (18).

Once the bootstrap key is obtained, the leaf-node 130 is able to get the MAC key, K_{MAC}, along with an 8-bit key identification number K_{#}.
(19) S→R: {I_{S}, I_{R}, N}K_{Bootstrap}
(20) R→S: {K_{MAC}, K_{#}, I_{S}, I_{R}, N}K_{Bootstrap}
(21) S [symbol] R: {Acknowledge}K_{MAC}
(22) R [symbol] S: {Status}K_{MAC}

As K_{#} is 8 bits wide, the 802.15.4 radio supports up to 256 keys for MAC encryption. These keys may be shared (broadcast, peer-to-peer communication) or unique per router-sensor pair. Note that sequences (21) and (22) use MAC (Link Layer) encryption key K_{MAC}.

The 802.15.4 packet specifications support 256 different keys and the key number K_{#} (which corresponds to Key_{#} in FIG. 15). The CC2420 only supports 2 keys in hardware; however, the leaf-nodes 130 can examine the header of the packet, determine the key number, install the matching key into either KEY0 or KEY1, and then decrypt the rest of the packet in hardware.

The status word is used to indicate pending actions for the leaf-node 130. This may include the number of keys pending, number of valid keys, and time until the current key expires. Therefore, the leaf-nodes 130 can repeat sequences 19-22 to obtain additional keys.

The router 120 keeps track of the keys known to each leaf-node 130. This allows the router 120 to change keys once it confirms that all of the leaf-nodes 130 know the new key. It also allows the router 120 to partition the knowledge of the subordinate leaf-nodes 130, allowing it to quickly exclude a compromised leaf-node 130.

At the end of each sequence, the leaf-node 130 will examine the status packet, and decide if it needs to perform additional actions. One of these actions is to ask for a new MAC key. This sequence is as follows:
(23) S→R: {I_{S}, I_{R}, N}K_{Bootstrap}
(24) R→S: {K_{MAC}, K_{#}, I_{S}, I_{R}, N}K_{Bootstrap}
(25) S [symbol] R: {Acknowledge}K_{MAC}
(26) R [symbol] S: {Status}K_{MAC}

Sequences 25 and 26 could also use MAC encryption as well for increased security. The router 120 can pre-load several keys in advance, and keep track of which leaf-nodes 130 know which key numbers, which allows the router 120 to smoothly switch to a new MAC key by selecting one known to all devices. It can purposely exclude or isolate devices by category if it needs to. Key changes can be synchronized by clock as well, with the status telling the sensor the time until the next key change.

If a device discovers it no longer has a valid MAC key, it can fall back to (19) or even (13) to obtain the key.

While the network 90 is in operation, devices can be physically attacked. Inhibiting these attacks is difficult. An alarm mechanism is added to the architecture sequences to respond to a detected intrusion attack, either physical or over the network 90 (i.e. brute force, replay, etc.):
(27) S [symbol] R: {Alarm}K_{MAC}
(28) R [symbol] S: {Status}K_{MAC}
(29)

When a physical attack is detected, the leaf-node 130 sends an alert to allow the router 120 and site authority (gateway server 110) to react in a series of escalations. The site authority may first change any shared K_{MAC}. The site authority can then revoke the K_{Bootstrap} key and temporarily prevent any new key from being issued. Finally, the K_{V} key can be revoked.

It may be possible for an attacker to physically compromise a device without detection, while the device is connected to the network 90 and obtain the keys stored within. Denial-of-service attacks are also possible. A leaf-node device 130 may also be physically removed from the network 90. To prevent such attacks, a heartbeat function is used to detect attacks on the leaf-nodes 130 as well as unavailable or missing devices.
(29) S [symbol] R: {I_{S}, I_{R}, N₁}K_{MAC}
(30) R [symbol] S: {{I_{S}, I_{R}, N₁, N₂} K_{Bootstrap}}K_{MAC}
(31) S [symbol] R: {I_{S}, I_{R}, N₂}K_{MAC}
(32) R [symbol] S: {Status}K_{MAC}

Sequences (29) thru (32) allows the router 120 to authenticate each leaf-node 130 and check its status through a heartbeat function. Routers 120 can summarize the status information and pass it up to the site authority. The response from the site authority or router 120 to a missing leaf-node 130 can escalate in time, as mentioned earlier. Keys issued to the leaf-node 130 can be changed, temporarily prevented from re-issuing and finally revoked.

Up to this point, the framework provides link-to-link authentication. However, a trusted but compromised router 120 could also modify data en route. In one embodiment, intrusion detection devices are used to log and inspect packet contents, and optionally decrypt data. In order to enable this packet inspection, an end-to-end authenticity key KA is installed in link-layer (7)-(9). A leaf-node 130 uses this to sign and/or encrypt data in addition to MAC-encryption. Any device that knew this key could authenticate and decrypt the data, but it would be unable to join the network 90 or obtain the MAC-layer key used for that link. The routers 120 log the packets generated.

The key installation protocol is used over-the-air to update/replace the end-to-end authentication key, while giving the old key to intrusion detection devices.

TinyOS® provides a way to update software with the “Deluge” extension. In one embodiment, the firmware is transmitted using MAC encryption, and hash of the firmware H, along with the revision identification IREV, be signed by Ks:
(29) R [symbol] S: {{H, I_{REV}}K_{S}}K_{MAC}

In general, the vendor creates K_{V}, and the customer site authority creates the other keys. Optionally the router 120 may create K_{MAC} for efficiency reasons.

The keys can be revoked under conditions listed in Table 1. Note that if a key is revoked, the key in the row above it must be used to obtain another key.

TABLE 1
Key Revocation Conditions

| Key | Revocation Condition |
|---|---|
| K_{V} | Unauthorized reproduction of device |
| (DK) | Large shipment of devices stolen |
| | Key expired (if using two vendor keys) |
| K_{S} | Device stolen, missing, or compromised |
| (DSK) | Device sold or redeployed |
| K_{Bootstrap} | Key expired |
| (BK) | Device under attack |
| K_{MAC} | Key expired/updated |
| (SK) | Unauthorized device on network |
| K_{A} | Device expired/updated |
| | Key exported for analysis |

The vendor may also revoke individual keys if desired, in high-security situations. A more practical approach is to simply let the vendor key expire.

Different sites can determine the number of K_{MAC} keys to use. One site can use a single shared key, a second can use one key for each router 120, and a third can use unique keys for every link.

In some devices, authentication may use less power than encryption and authentication. Therefore, authentication alone may be preferable to save power. There are many other power optimization techniques that may be applied to this architecture as well.

The number of keys necessary to remember is proportional to the importance of a device in the infrastructure. Assuming the 4-key mechanism (K_{V}, K_{S}, K_{Bootstrap}, K_{MAC}), an end-node sensor would need to know 2+2N keys, where N is the number of mesh routers 150 it talks to. A mesh router 150, with N peer routers 120, and M leaf-nodes 130, would need to know up to 2+2N+2M keys. Because of the limitations in the 802.15.4 framework, each router 120 or mesh router 150 is limited to 256 different MAC-layer keys. The KDC has the greatest burden, by needing to know all of the keys. The worst case would be unique K_{MAC} keys, with every device able to communicate with every other device.

While the invention has been described with reference to only a limited number of exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for providing a network device authentication in a communications network, the system comprising:
a network gateway;
a plurality of wireless routers;
a plurality of leaf-node sensors, each having a unique device key; and
wherein the network gateway and the plurality of wireless routers authenticates at least one of the plurality of leaf-node sensors for connecting to the communications network in a system wherein each unique device key is stored in the network gateway so that the network gateway can authenticate each of the plurality of leaf-node sensors;
the network gateway creates a device site key for at least one of the authenticated plurality of leaf-node sensors;
at least one of the authenticated plurality of leaf-nodes sensors sends a communication request authenticated with its unique device key and its device site key to at least one of the plurality of wireless routers and the least one of the plurality of wireless routers passes the communication request to the network gateway and the network gateway verifies the unique device key and the device site key to authorize the at least one of the plurality of wireless routers to have a direct link-level communication with the at least one of the authenticated plurality of leaf-nodes sensors.

2. The system according to claim 1, wherein the authorized at least one of the plurality of wireless routers initiates direct link-level communication with the at least one of the authenticated plurality of leaf-nodes sensors by creating a leaf-node router key which is sent to the at least one of the authenticated plurality of leaf-nodes sensors in response to the communication request.

3. The system according to claim 2, wherein the at least one of the authenticated plurality of leaf-node sensors sends a response to the authorized at least one of the plurality of wireless routers acknowledging that it has received the leaf-node router key and wherein the authorized at least one of the plurality of wireless routers responds to the acknowledgement with a session key that is authenticated with the unique device key, the device site key and the leaf-node router key to allow link-level communications between the authorized at least one of the plurality of wireless routers and the at least one of the authenticated plurality of leaf-nodes sensors.

4. The system according to claim 3, wherein the network gateway serves as a key authority for storing and authenticating the unique device key, the device site key, the leaf-node router key and the session key used in the communications network.

5. The system according to claim 4, wherein the leaf-node router key and the session key is encrypted with a nonce.

6. The system according to claim 4, wherein the network gateway serving as the key authority can revoke the device site key, the leaf-node router key and the session key of any the authenticated plurality of leaf-nodes sensors that fall subject to unauthorized activity.

7. The system according to claim 1, wherein any of the at least one of the authenticated plurality of leaf-nodes sensors can act as an authorized at least one of the plurality of wireless routers to another one of the at least one of the authenticated plurality of leaf-nodes sensors.

8. The system according to claim 1, wherein the network gateway, the authorized at least one of the plurality of wireless routers and any of the at least one of the authenticated plurality of leaf-nodes sensors are synchronized using a heart beat signal such that the network gateway can used the heart beat signal to verify if any of the at least one of the authenticated plurality of leaf-nodes sensors is still connected to the communications network.

9. A method for providing a network device authentication architecture in a wireless network, the method comprising:
installing a unique device key in a network device;
executing in a gateway server an authentication process for issuing and storing a plurality of keys and creating a chain of keys, wherein a subsequent key is encrypted using a previous key, and wherein the authentication process:
installs a device site key in the network device using the unique device key;
authenticates the network device for communicating with a wireless network router using the unique device key and the device site key, and wherein the wireless network router creates a network-device-router key using the unique device key and the device site key, and wherein the wireless network router enables link-layer communications with the network device using the unique device key, the device site key and network-device-router key to creates a session key for communicating over the wireless network.

10. The method according to claim 9, wherein a gateway server serves as the key authority for storing and revoking the plurality of keys during various states of the authentication process.

11. The method according to claim 9, wherein the unique device key contains a code that is unique to each network device and is installed in each network device over a physically secure connection.

12. The method according to claim 11, wherein the device site key is authenticated using the unique device key.

13. The method according to claim 12, wherein the network device requests a network-device-router key from the wireless network router and the wireless network router forwards the request to a gateway server, wherein the gateway server authenticates the network device using the unique device key and the device site key and responds to the wireless network router with an authorization sequence to enable the wireless network router to have link-layer communications directly with the network device.

14. The method according to claim 9, wherein one network device may store more than one session key as required by the wireless network.

15. The method according to claim 14, wherein the wireless network router tracks the session keys stored in a network device and can change an active session key or partition a knowledge of active session keys to exclude certain network devices from encrypted link-layer communications over the wireless network.

16. The method according to claim 15, wherein an alarm mechanism may be added to the network device authentication architecture to respond to detected intrusion attacks, wherein an attacked network device sends an alert to the wireless network router and the gateway server which may revoke any of the device site key, network-device-router key, or session key, thereby isolating the attacked network device.

17. The method according to claim 9, having a network heart beat for synchronizing the gateway server, the wireless network routers and network devices, such that a synchronization sequence can be used to verify a network device is still connected to the wireless network.

18. A method for providing wireless network device authentication, the method comprising:
providing a network server;
providing a wireless network router;
providing a plurality of network devices, each of the plurality of network devices having a unique Key1;
creating a chain of keys within the network server, wherein a subsequent key is encrypted using a previous key and executes an authentication process for storing keys within the network server, wherein the authentication process comprises:
installing a Key2 in at least one of the plurality of network devices over a physically secure connection between the at least one of the plurality of network devices and the network server, wherein the network server authenticates the at least one of the plurality of network devices using the unique Key1;
querying using Key1 and Key2 from the at least one of the plurality of network devices to a wireless network router for a Key3, wherein the wireless network router forwards the query to the network server using Key1 and Key2 and seeks permission to provide Key3 to the at least one of the plurality of network devices and the network server allows the wireless network router to provide Key3 to the at least one of the plurality of network devices once Key1 and Key2 are authenticated,
querying using Key1, Key2 and Key3 from the at least one of the plurality of network devices to a wireless network router for a Key4, wherein the wireless network router provides Key4 to the at least one of the plurality of network devices once Key1, Key2 and Key3 are authenticated, and
enabling link-layer communications to occur between the at least one of the plurality of network devices, the wireless network router and the gateway server once Key4 is provided to the at least one of the plurality of network devices, which creates a secure encrypted link-layer communications network over the wireless network based on Key1, Key2, Key3 and Key4.

19. The method according to claim 18, wherein the network server can revoke any one of Key2, Key3, or Key4 from at least one of the plurality of network devices to prohibit the at least one of the plurality of network devices from communicating over the secure encrypted link layer communications network.

20. The method according to claim 19, wherein at least one of the plurality of network devices may contain multiple Key4 keys depending on a requirement of the secure encrypted link-layer communications network.
